(19) United States
(12) Patent Application Publication
(10) Pub. No.: US 2018/0058350 A1
(43) Pub. Date: Mar. 1, 2018

(54) METHOD AND APPARATUS FOR CONTROLLING OPERATION OF AN INTERNAL COMBUSTION ENGINE

(71) Applicant: GM GLOBAL TECHNOLOGY OPERATIONS LLC, Detroit, MI (US)

(72) Inventors: Yongjie Zhu, Troy, MI (US); Jun-mo Kang, Ann Arbor, MI (US); Chen-fang Chang, Bloomfield Hills, MI (US)

(73) Assignee: GM GLOBAL TECHNOLOGY OPERATIONS LLC, Detroit, MI (US)

(21) Appl. No.: 15/253,169

(22) Filed: Aug. 31, 2016

(51) Int. Cl. F02D 41/00; F02D 13/02; F02D 41/26; F02B 17/00; F02B 75/18

(52) U.S. Cl. CPC F02D 41/0002; F02D 13/0215; F02B 75/18; F02D 41/26; F02B 17/005; F02D 13/0261

(57) ABSTRACT

An internal combustion engine is described. Controlling the internal combustion engine includes gathering engine operating data during steady-state engine operation, including gathering a first dataset associated with a cylinder air charge during steady-state operation of the engine in the PVO state and gathering a second dataset associated with a cylinder air charge during steady-state operation of the engine in the NVO state. An optimization routine is executed to determine a first subset of parameters associated with a first relationship for a cylinder air charge model based upon the second dataset. The optimization routine is also executed to determine a second subset of parameters associated with a second relationship for the cylinder air charge model based upon the first dataset. A cylinder air charge is determined in real-time during engine operation based upon the cylinder air charge model and the first and second subsets of parameters.

### TECHNICAL FIELD

This disclosure relates to operation of an internal combustion engine, including determining a cylinder air charge.

### BACKGROUND

Known spark-ignition (SI) engines introduce an air-fuel mixture into each cylinder that is compressed in a compression stroke and ignited by a spark plug. Known compression-ignition (CI) engines inject pressurized fuel into a combustion cylinder near top dead center (TDC) of the compression stroke that ignites upon injection. Combustion for both SI engines and CI engines involves premixed or diffusion flames controlled by fluid mechanics.

SI engines may operate in different combustion modes, including a homogeneous SI combustion mode and a stratified-charge SI combustion mode. SI engines may be configured to operate in a homogeneous-charge compression-ignition (HCCI) combustion mode, also referred to as controlled auto-ignition combustion, under predetermined speed/load operating conditions. HCCI combustion is a distributed, flameless, kinetically-controlled auto-ignition combustion process with the engine operating at a dilute air-fuel mixture, i.e., lean of a stoichiometric air/fuel point, with relatively low peak combustion temperatures, resulting in low NOx emissions. An engine operating in the HCCI combustion mode has a cylinder charge that is preferably homogeneous in composition, temperature, and residual exhaust gases at intake valve closing time. The homogeneous air-fuel mixture minimizes occurrences of rich in-cylinder combustion zones that form particulate matter.

Engine airflow may be controlled by selectively adjusting position of the throttle valve and opening and closing of intake valves and exhaust valves. On engine systems so equipped, opening and closing of the intake valves and exhaust valves may be adjusted using a variable valve actuation system that includes variable cam phasing and a selectable multi-step valve lift, e.g., multiple-step cam lobes that provide two or more valve lift positions. In contrast to the throttle position change, the change in valve position of the multi-step valve lift mechanism may be a discrete step change.

When an engine operates in a HCCI combustion mode, the engine preferably operates at a lean or stoichiometric air/fuel ratio operation with the throttle wide open to minimize engine pumping losses. When the engine operates in the SI combustion mode, the engine preferably operates at or near a stoichiometric air/fuel ratio, with the throttle valve controlled over a range of positions from 0% to 100% of the wide-open position to control intake airflow to achieve the stoichiometric air/fuel ratio.

Combustion during engine operation in the HCCI combustion mode is affected by cylinder charge gas temperature before and during compression prior to ignition and by mixture composition of a cylinder charge. Known engines operating in auto-ignition combustion modes account for variations in ambient and engine operating conditions using calibration tables as part of an overall engine control scheme. Known HCCI engine control schemes include calibrations for controlling engine parameters using input parameters including, e.g., engine load, engine speed and engine coolant temperature. Cylinder charge gas temperatures may be affected by controlling hot gas residuals via engine valve overlap and controlling cold gas residuals via exhaust gas recirculation. Cylinder charge gas temperatures, pressure, composition may be influenced by engine environment factors, including, e.g., air temperature, humidity, altitude, and fuel parameters, e.g., RVP, energy content, and quality. A cylinder air charge is affected by the cylinder charge gas temperature and other factors.

### SUMMARY

A direct-injection, multi-cylinder internal combustion engine is described, and includes a plurality of intake valves and exhaust valves that are disposed to control intake airflow into the cylinders and exhaust gas flow out of the cylinders. A first device is disposed to control openings and closings of the intake valves, and a second device is disposed to control openings and closings of the exhaust valves. The first and second devices are disposed to control the intake valves and exhaust valves in one of a positive valve overlap (PVO) state and a negative valve overlap (NVO) state.

Controlling the internal combustion engine includes gathering engine operating data during steady-state engine operation, including gathering a first dataset associated with a cylinder air charge during steady-state operation of the engine in the PVO state and gathering a second dataset associated with a cylinder air charge during steady-state operation of the engine in the NVO state. An optimization routine is executed to determine a first subset of parameters associated with a first relationship for a cylinder air charge model based upon the second dataset associated with steady-state operation of the engine in the NVO state. The optimization routine is also executed to determine a second subset of parameters associated with a second relationship for the cylinder air charge model based upon the first dataset associated with steady-state operation of the engine in the PVO state. A cylinder air charge is determined in real-time during engine operation based upon the cylinder air charge model and the first and second subsets of parameters.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates a cross-sectional view of a spark-ignition internal combustion engine and an accompanying controller in accordance with the present disclosure;

FIG. 2 schematically illustrates a control routine to provide a real-time adaptation of an air charge model, in accordance with the disclosure;

FIG. 3 graphically illustrates parameters associated with an optimization process, including a first of the parameters shown on the horizontal axis and a second of the parameters shown on the vertical axis, in accordance with the disclosure.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure. Furthermore, the drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

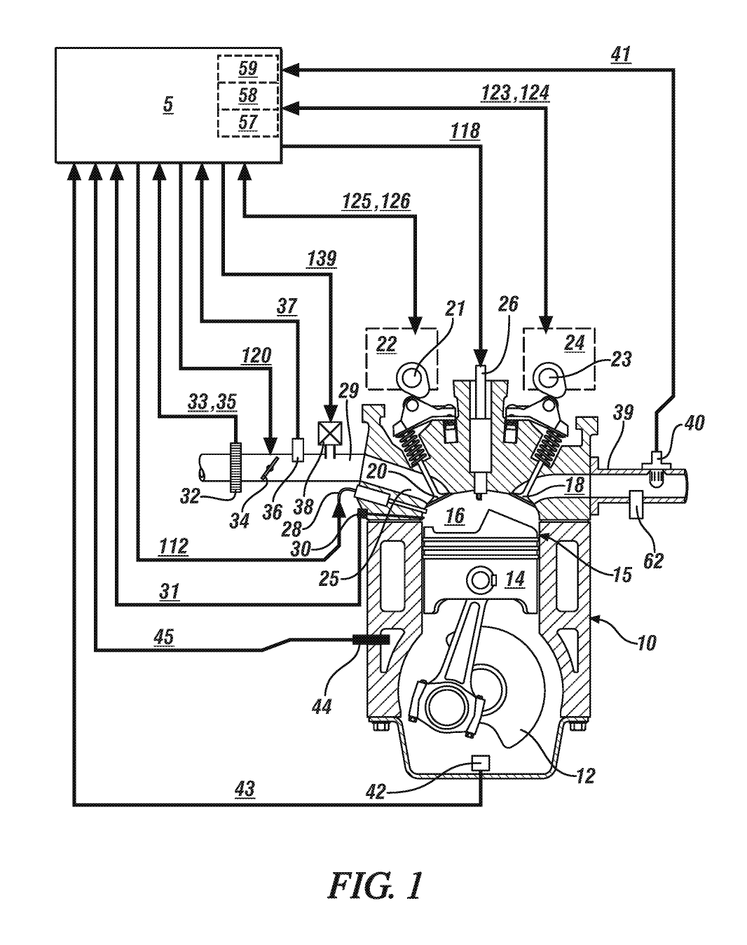

Referring now to the drawings, wherein the depictions are for the purpose of illustrating certain exemplary embodiments only and not for the purpose of limiting the same, FIG. 1 schematically illustrates a cross-sectional view of an internal combustion engine 10 with an accompanying controller 5 that have been constructed in accordance with an embodiment of this disclosure. The engine 10 operates in one of a plurality of selectable combustion modes, including a homogeneous-charge compression-ignition (HCCI) combustion mode and a spark-ignition (SI) combustion mode. The engine 10 is configured to operate at a stoichiometric air/fuel ratio and at an air/fuel ratio that is primarily lean of stoichiometry. The disclosure may be applied to various internal combustion engine systems and cylinder events.

The exemplary engine 10 includes a multi-cylinder direct-injection four-stroke internal combustion engine having reciprocating pistons 14 slidably movable in cylinders 15 which define variable volume combustion chambers 16. Each piston 14 is connected to a rotating crankshaft 12 by which linear reciprocating motion is translated to rotational motion. An air intake system provides intake air to an intake manifold 29 which directs and distributes air into intake runners of the combustion chambers 16. The air intake system has airflow ductwork and devices for monitoring and controlling the airflow. The air intake devices preferably include a mass airflow sensor 32 for monitoring mass airflow (MAF) 33 and intake air temperature (IAT) 35. A throttle valve 34 preferably includes an electronically controlled device that is used to control airflow to the engine 10 in response to a control signal (ETC) 120 from the controller 5. A pressure sensor 36 in the intake manifold 29 is configured to monitor manifold absolute pressure (MAP) 37 and barometric pressure. An external flow passage recirculates exhaust gases from engine exhaust to the intake manifold 29, having a flow control valve referred to as an exhaust gas recirculation (EGR) valve 38. The controller 5 controls mass flow of exhaust gas to the intake manifold 29 by controlling opening of the EGR valve 38 via EGR command (EGR) 139.

Airflow from the intake manifold 29 into the combustion chamber 16 is controlled by one or more intake valve(s) 20 interacting with an intake camshaft 21 that rotationally couples to the crankshaft 12. Exhaust flow out of the combustion chamber 16 to an exhaust manifold 39 is controlled by one or more exhaust valve(s) 18 interacting with an exhaust camshaft 23 that rotationally couples to the crankshaft 12. The engine 10 is equipped with systems to control and adjust openings and closings of the intake and exhaust valves 20 and 18. In one embodiment, the openings and closings of the intake and exhaust valves 20 and 18 may be controlled and adjusted by controlling intake and exhaust variable cam phasing/variable lift control (VCP/VLC) devices 22 and 24 respectively. The intake and exhaust VCP/VLC devices 22 and 24 are configured to control and operate the intake camshaft 21 and the exhaust camshaft 23, respectively. The rotations of the intake and exhaust camshafts 21 and 23 are linked to and indexed to rotation of the crankshaft 12, thus linking openings and closings of the intake and exhaust valves 20 and 18 to positions of the crankshaft 12 and the pistons 14.

The intake VCP/VLC device 22 preferably includes a mechanism operative to switch and control valve lift of the intake valve(s) 20 in response to a control signal (iVLC) 125 and variably adjust and control phasing of the intake camshaft 21 for each cylinder 15 in response to a control signal (iVCP) 126. The exhaust VCP/VLC device 24 preferably includes a controllable mechanism operative to variably switch and control valve lift of the exhaust valve(s) 18 in response to a control signal (eVLC) 123 and variably adjust and control phasing of the exhaust camshaft 23 for each cylinder 15 in response to a control signal (eVCP) 124.

The intake and exhaust VCP/VLC devices 22 and 24 each preferably includes a controllable two-step VLC mechanism operative to control the magnitude of valve lift, or opening, of the intake and exhaust valve(s) 20 and 18, respectively, to one of two discrete steps. The two discrete steps preferably include a low-lift valve open position (about 4-6 mm in one embodiment) preferably for low speed, low load operation, and a high-lift valve open position (about 8-13 mm in one embodiment) preferably for high speed and high load operation. The intake and exhaust VCP/VLC devices 22 and 24 each preferably includes a variable cam phasing mechanism to control and adjust phasing (i.e., relative timing) of opening and closing of the intake valve(s) 20 and the exhaust valve(s) 18 respectively. Adjusting phasing refers to shifting opening times of the intake and exhaust valve(s) 20 and 18 relative to positions of the crankshaft 12 and the piston 14 in the respective cylinder 15. The VCP mechanisms of the intake and exhaust VCP/VLC devices 22 and 24 each preferably has a range of phasing authority of about 60°-90° of crank rotation, thus permitting the controller 5 to advance or retard opening and closing of one of intake and exhaust valve(s) 20 and 18 relative to position of the piston 14 for each cylinder 15. The range of phasing authority is defined and limited by the intake and exhaust VCP/VLC devices 22 and 24. The intake and exhaust VCP/VLC devices 22 and 24 include camshaft position sensors to determine rotational positions of the intake and the exhaust camshafts 21 and 23. The VCP/VLC devices 22 and 24 are actuated using one of electro-hydraulic, hydraulic, and electric control force, in response to the respective control signals eVLC 123, eVCP 124, iVLC 125, and iVCP 126. In the present disclosure, the term “positive valve overlap” or PVO refers to engine operation in which the intake valve 20 starts to open before the exhaust valve 18 has closed during a cylinder event. In the present disclosure, the term “negative valve overlap” or NVO refers to engine operation in which the intake valve 20 starts to open only after the exhaust valve 18 has closed during a cylinder event.

The engine 10 employs a direct-injection fuel injection system including a plurality of high-pressure fuel injectors 28 that are configured to directly inject a mass of fuel into one of the combustion chambers 16 in response to an injector pulsewidth command (INJ_PW) 112 from the controller 5. The fuel injectors 28 are supplied pressurized fuel from a fuel distribution system. The engine 10 employs a spark-ignition system by which spark energy may be provided to a spark plug 26 for igniting or assisting in igniting cylinder charges in each of the combustion chambers 16 in response to a spark command (IGN) 118 from the controller 5.

The engine 10 is equipped with various sensing devices for monitoring engine operation, including a crank sensor 42 having an output indicative of crankshaft rotational position, i.e., crank angle and speed (RPM) 43. A temperature sensor 44 is configured to monitor coolant temperature 45. An in-cylinder combustion sensor 30 is configured to monitor combustion, and is a cylinder pressure sensor operative to monitor in-cylinder combustion pressure 31 in one embodiment. An exhaust gas sensor 40 is configured to monitor an exhaust gas parameter 41, e.g., air/fuel ratio (AFR). The combustion pressure 31 and the RPM 43 are monitored by the controller 5 to determine combustion timing, i.e., timing of combustion pressure relative to the crank angle of the crankshaft 12 for each cylinder 15 for each cylinder event. It is appreciated that combustion timing may be determined by other methods.

The combustion pressure 31 may be monitored by the controller 5 to determine an indicated mean effective pressure (IMEP) for each cylinder 15 for each cylinder event. Preferably, the engine 10 and controller 5 are configured to monitor and determine states of IMEP for each of the engine cylinders 15 during each cylinder firing event. Alternatively, other sensing systems may be used to monitor states of other combustion parameters within the scope of the disclosure, e.g., ion-sense ignition systems, EGR fractions, and non-intrusive cylinder pressure sensors.

The terms controller, control module, module, control, control unit, processor and similar terms refer to any one or various combinations of Application Specific Integrated Circuit(s) (ASIC), electronic circuit(s), central processing unit(s), e.g., microprocessor(s), a non-transitory memory component 57 and first and second data buffers 58, 59, respectively, which are transitory memory components. The non-transitory memory component 57 may be in the form of memory and storage devices (read only, programmable read only, random access, hard drive, etc.), and is capable of storing machine readable instructions in the form of one or more software or firmware programs or routines, combinational logic circuit(s), input/output circuit(s) and devices, and other components that can be accessed by one or more processors to provide a described functionality. The first and second data buffers 58, 59 may include signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean any controller-executable instruction sets including calibrations and look-up tables. Each controller executes control routine(s) to provide desired functions, including monitoring inputs from sensing devices and other networked controllers and executing control and diagnostic instructions to control operation of actuators. Routines may be executed at regular intervals, for example each 100 microseconds during ongoing operation. Alternatively, routines may be executed in response to occurrence of a triggering event. Communication between controllers, and communication between controllers, actuators and/or sensors may be accomplished using a direct wired point-to-point link, a networked communication bus link, a wireless link or any other suitable communication link. Communication includes exchanging data signals in any suitable form, including, for example, electrical signals via a conductive medium, electromagnetic signals via air, optical signals via optical waveguides, and the like. The data signals may include discrete, analog or digitized analog signals representing inputs from sensors, actuator commands, and communication between controllers. The term “signal” refers to any physically discernible indicator that conveys information, and may be any suitable waveform (e.g., electrical, optical, magnetic, mechanical or electromagnetic), such as DC, AC, sinusoidal-wave, triangular-wave, square-wave, vibration, and the like, that is capable of traveling through a medium. The term ‘model’ refers to a processor-based or processor-executable code and associated calibration that simulates a physical existence of a device or a physical process. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine. As used herein, the term “real-time” is used to refer to a response that is expected to occur within a preset response time after an event, wherein the preset response time is such that it permits the event to influence the response. By way of a non-limiting example, an estimation of a cylinder air charge is said to be “real time” when the event of estimating the cylinder air charge is employed by a controller to control a response that is in the form of determining a magnitude of fueling for that cylinder event.

The controller 5 transitions engine operation to a preferred combustion mode associated with operating the engine 10 in the HCCI combustion mode or the SI combustion mode to increase fuel efficiencies and engine stability, and/or decrease emissions in response to the operator torque request. A change in one of the engine parameters, e.g., speed or load, may effect a change in a preferred combustion mode.

During engine operation in the spark-ignition combustion (SI) mode, the throttle valve 34 may be controlled to regulate the airflow. The engine 10 may be controlled to a stoichiometric air/fuel ratio with the intake and exhaust valves 20 and 18 in the high-lift valve open position and the intake and exhaust lift timing operating with PVO. Preferably, a fuel injection event is executed during intake or compression phase of an engine cycle, preferably substantially before TDC. Spark-ignition is preferably discharged at a predetermined time subsequent to the fuel injection when the cylinder air charge is substantially homogeneous. When operating the engine 10 in the SI combustion mode, the intake backflow includes not only air, but also a portion of residual exhaust gas mass from the previous engine cycle and a portion of the fuel mass injected in the cylinder 15. The mass pushed to the intake port by the piston 14 is re-inducted during the next engine intake cycle, and thus a portion of cylinder gas volume is always occupied by the re-inducted mass except for the first cycle following a transition into SI mode.

When the engine 10 is operating in the HCCI combustion mode with NVO, combustion and combustion timing may be described in the context of combustion heat release during a cylinder event, e.g., a magnitude and timing of combustion heat release during each cylinder event. The magnitude and timing of the combustion heat release may be indicated by cylinder pressure, a mass-burn-fraction or other parameters.

During operation of the engine 10, the controller 5 executes instruction sets to determine a cylinder air charge for each cylinder event, which may be advantageously employed to control engine fueling in response to an output power request from an operator, taking into consideration other factors that may be related to fuel economy and emissions. The cylinder air charge for each cylinder event is determined based upon a difference between a cylinder volume at BDC (or when the intake valve closes) and a residual gas volume. The residual gas volume can be determined employing direct measurement methods and/or estimation methods, as described with reference to EQS. 1 and 2. The cylinder air charge for each cylinder event may be determined employing direct measurement methods and/or estimation methods. One estimation method includes a physics-based air charge model, wherein parameters related to a physics-based air charge model may be represented by the following relationships set forth in EQS. 1 and 2, which can be reduced to executable code.

The intake port residual gas volume Vᵣₑₛ^{IP} represents the residual gas volume that is pushed to the intake port and re-inducted in the next cycle, and may be determined in accordance with the relationship:

$${V}_{res}^{IP} ( n + 1 ) = {V}_{res}^{BDC} ( n ) \times ( 1 - \frac{{V}_{IVC} ( n \text{:} {k}_{5} )}{{V}_{BDC} ( n )} ) \qquad [ 1 ]$$

wherein
Vᵣₑₛ^{BDC}(n) is total residual gas volume when the piston 14 is at the BDC position for the current engine cycle, n;
V_{IVC}(n) is the cylinder volume when the intake valve 20 closes during the current engine cycle, n;
V_{BDC}(n) is the cylinder volume when the piston 14 is at the BDC position for the current engine cycle, n; and
Vᵣₑₛ^{IP}(n+1) is the volume of the residual gas trapped in the intake port 25 that will be re-inducted into the cylinder 15 during the next engine cycle, n+1.

Thus, the residual gas volume in the intake port originating from the previous engine cycle Vᵣₑₛ^{IP} is zero if the intake port 25 closes before a crank angle is equal to or less than 180 degrees. Further, the residual gas volume in the intake port 25 originating from the previous engine cycle Vᵣₑₛ^{IP} is based, at least in part, on the exhaust manifold pressure and the intake manifold pressure if the intake port 25 closes after the crank angle is greater than 180 degrees.

The total residual gas volume Vᵣₑₛ^{BDC} when the piston 14 is at the BDC position can be estimated for each engine cycle. The total residual gas volume Vᵣₑₛ^{BDC} when the piston 14 is at the BDC position is based, at least in part, on the cylinder residual gas volume Vᵣₑₛ and the intake port residual gas volume Vᵣₑₛ^{IP}. The controller 5 is specifically programmed to determine the total residual gas volume Vᵣₑₛ^{BDC} based, at least in part, on the cylinder residual gas volume Vᵣₑₛ and the intake port residual gas volume Vᵣₑₛ^{IP}. Specifically, the total residual gas volume Vᵣₑₛ^{BDC} at BDC may be determined in accordance with the following equation:

$${V}_{res}^{BDC} ( n ) = {k}_{1} \times {V}_{res}^{IP} ( n ) + {{k}_{2} ( \frac{{p}_{EM}}{{p}_{IM}} )}^{\frac{1}{γ}} {V}_{EVC} ( n \text{:} {k}_{7} ) + {V}_{res}^{PVO} ( n \text{:} {k}_{3} , {k}_{4} , {k}_{6} , {k}_{7} ) \qquad [ 2 ]$$

wherein:
n represents the engine cycle (i.e., the current engine cycle),
Vᵣₑₛ^{IP}(n) is the residual gas volume forced into the intake port 25 in a previous engine cycle and re-inducted to the cylinder 15 in the current cycle, and can be determined using the relationship of EQ. 1,
P_{IM} is intake manifold pressure,
P_{EM} is exhaust manifold pressure,
γ is the ratio of specific heats for an ideal gas,
Vᵣₑₛ(n) is the residual gas volume in the cylinder 15 originating from the current engine cycle, and
Vᵣₑₛ^{BDC}(n) is the total residual gas volume when the piston 14 is at the BDC position for the current engine cycle.
k₁ is a scalar to account for the residual gas volume reduction due to heat transfer at the intake port 25 until the residual gas is re-inducted into the cylinder 15 in the next cycle (0<k₁<1),
k₂ is a scalar to account for the residual gas volume reduction due to heat loss to the cylinder wall,
k₃ is a scalar that is associated with a mass to volume factor,
k₄ is a scalar that is associated with a crank angle at which flow to intake stops during PVO, and
k₅, k₆ and k₇ are scalars that are associated with valve timing bias.

The controller 5 can determine the intake manifold pressure P_{IM} based on an input signal received from the first pressure sensor 36. Likewise, the controller 5 can receive an input signal from the second pressure sensor 62 and determine the exhaust manifold pressure P_{EM} based on the input signal received from the second pressure sensor 62. The ratio of specific heats γ is about 1.67 for a monoatomic gas and 1.4 for a diatomic gas. The controller 5 may store the ratio of specific heats γ in the non-transitory memory component 57. Thus, a total residual gas volume can be determined when the piston 14 is at the BDC position based, at least in part, on the residual gas volume in the cylinder originating from the current engine cycle and the residual gas volume in the cylinder originating from the previous engine cycle.

A cylinder air charge when the piston 14 is at the BDC position V_{BDC} can be determined by calculating a difference between the cylinder volume in the cylinder 15 when the piston 14 is at the BDC position and the total residual gas volume Vᵣₑₛ^{BDC}, which includes the cylinder residual gas volume Vᵣₑₛ and the intake port residual gas volume Vᵣₑₛ^{IP}, and is determined employing EQ. 2.

To break down the complex nonlinear multivariable optimization problem, the parameters are categorized. The scalars k₁, k₂, k₅ and k₇ represent a first subset of the parameters that is associated with engine operation that includes NVO, and the scalars k₃, k₄ and k₆ represent a second subset of the parameters that is associated with engine operation that includes PVO. Initial values for the scalars k₁-k₇ may be determined during development of the powertrain system.

A model may be advantageously implemented to provide real-time estimation of the cylinder air charge employing EQS. 1 and 2 and the scalars k₁-k₇. The scalars k₁-k₇ for the air charge model affects the air charge estimation, especially during transient engine cycles during which signal output from the mass airflow sensor 32 may not accurately represent the actual intake airflow. The cylinder air charge model is nonlinear and has multiple variables, resulting is local minimums and/or local maximums.

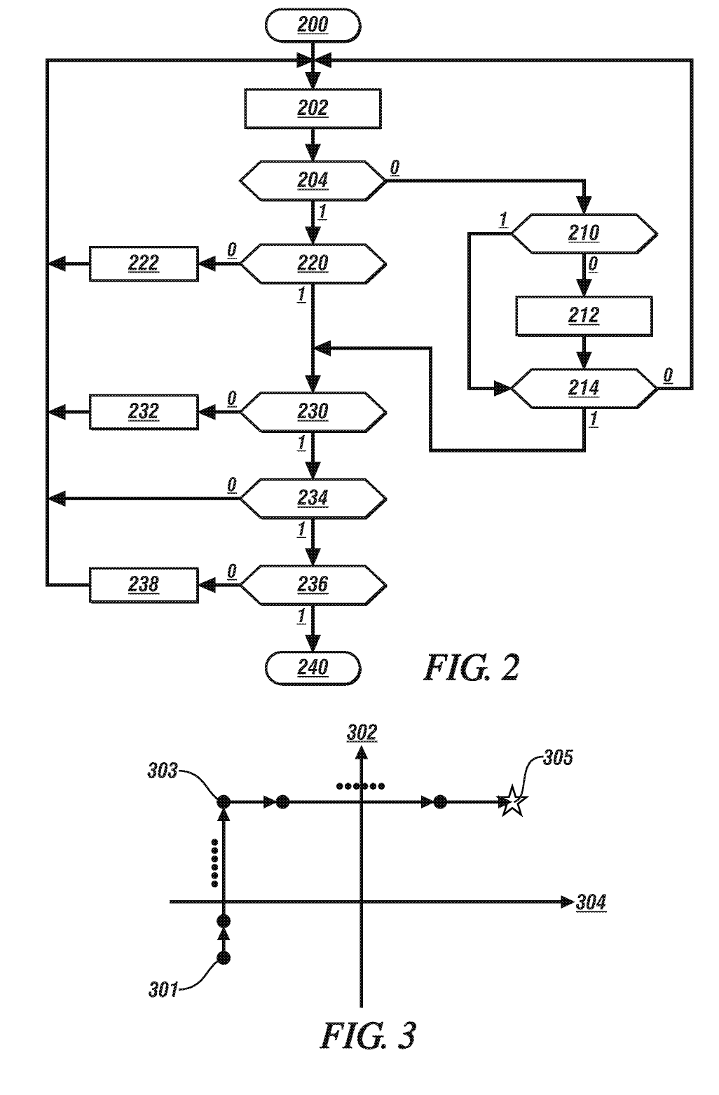

FIG. 2 schematically shows a known real-time optimization routine 200 that may be advantageously employed to determine and update calibratable parameters such as the scalar k₁-k₇ parameter set for the cylinder air charge model that includes EQS. 1 and 2, wherein the cylinder air charge model is employed to control an embodiment of the direct-injection, multi-cylinder internal combustion engine 10 that is described with reference to FIG. 1 wherein the intake valves 20 and exhaust valves 18 are controllable in one of a PVO state and an NVO state.

Overall, the controller 5 includes a first instruction set that is executable to determine a cylinder air charge during operation in the PVO state, and a second instruction set that is executable to determine a cylinder air charge during operation in the NVO state. The first instruction set includes a first relationship, e.g., EQ. 1, above, which includes a first set of calibratable parameters, i.e., the first subset of parameters that includes scalars k₁, k₂, k₅ and k₇. The second instruction set including a second relationship, e.g., EQ. 2, above, which includes a second set of calibratable parameters, i.e., the second subset of parameters that includes scalars k₃, k₄ and k₆. The real-time optimization routine 200 is in the form of a third instruction set that is executable to determine preferred states for the first and second sets of calibratable parameters, i.e., the scalars k₁-k₇. Table 1 is provided as a key wherein the numerically labeled blocks and the corresponding functions are set forth as follows, corresponding to the real-time optimization routine 200. Those having ordinary skill in the art will recognize that the teachings may be described herein in terms of functional and/or logical block components and/or various processing steps. Such block components may be composed of any number of hardware, software, and/or firmware components configured to perform the specified functions.

TABLE 1

| BLOCK | BLOCK CONTENTS |
|---|---|
| 202 | Collect SS data |
| 204 | Is engine operating in NVO? |
| 210 | Is first data buffer filled? |
| 212 | Fill first data buffer |
| 214 | Is second data buffer filled? |
| 220 | Is second data buffer filled? |
| 222 | Fill second data buffer |
| 230 | Are NVO parameters converged? |
| 232 | Execute NVO optimization |
| 234 | Is first data buffer filled? |
| 236 | Are PVO parameters converged? |
| 238 | Execute PVO optimization |
| 240 | End |

A categorized optimization structure may result in a robust solution while reducing computational burden. The parameters may be categorized by operating conditions wherein some parameters are only involved with a particular operating condition.

Execution of the real-time optimization routine 200 may proceed as follows. The steps of the real-time optimization routine 200 may be executed in any suitable order, and may not limited to the order described with reference to FIG. 2. The real-time optimization routine 200 executes to update and learn only the ones of the first and second sets of calibratable parameters, i.e., the first and second subsets of the scalars k₁-k₇ that are associated with present operating conditions of the engine 10, instead of learning all the parameters together at the same time.

The real-time optimization routine 200 is executable to gather engine operating data during steady-state operation of the internal combustion engine 10 (202). The gathered engine operating data is used to populate first and second data buffers 58, 59 during steady-state operation. The first data buffer 58 may include steady-state engine operating data that is associated with engine operation in the PVO state and the second data buffer 59 may include steady-state engine operating data that is associated with engine operation in the NVO state. This includes filling, i.e., storing associated engine operating data in the first data buffer 58 associated with PVO operation via steps 204(0), 210(1), 210(0), 212, 214(0), 214(1) and 234(1) and 234(0), and storing associated engine operating data in the second data buffer 59 associated with NVO operation via steps 204(0), 220(0) and 222.

The NVO parameters are evaluated to determine if they have converged (230). When the NVO parameters have not converged (230)(0), an NVO optimization routine is executed (232). One embodiment of an optimization routine includes categorizing the parameters into at least two different groups that may be displayed in a hierarchical structure, such as a first group including the first subset of scalars k₁, k₂, k₅ and k₇ that are associated with engine operation that includes NVO, and a second group including the second subset of scalars k₃, k₄ and k₆ that are associated with engine operation that includes PVO. Under such conditions, the optimization routine presumes that the first subset of scalars k₃, k₄ and k₆ are known and may execute to look for other parameters which are only involved in another sub-model. A search direction is chosen from the coordinate directions with the best converging opportunity, and a multivariable cost function is minimized along one direction of the coordinates at a time. This is described in detail with reference to FIG. 3.

When the NVO parameters have converged (230)(1), and the first data buffer 58 is filled (234)(1), the PVO parameters are evaluated to determine if they have converged (236). When the PVO parameters have not converged (236)(0), a PVO optimization routine is executed (238). When the PVO parameters have converged (236)(1), this iteration ends (240). The updated NVO parameters and PVO parameters may be employed in instruction sets that include executable forms of EQS. 1 and 2 to estimate the cylinder air charge during each cylinder event.

The parameters include, in one embodiment, the first set of calibratable parameters, i.e., the first subset of scalars k₁, k₂, k₅ and k₇, which are associated with engine operation that includes NVO and the second set of calibratable parameters, i.e., the second subset of scalars k₃, k₄ and k₆, which are associated with engine operation that includes PVO.

The parameters may be categorized into different groups that may be displayed in a hierarchical structure, such as a first group including the first subset of scalars k₁, k₂, k₅ and k₇ and a second group including the second subset of scalars k₃, k₄ and k₆. For example, the scalars k₃, k₄ and k₆ are unknown parameters that are only involved in one sub-model. The optimization routine may assume the scalars k₃, k₄ and k₆ are known and may execute to determine other parameters which are only involved in another sub-model. These parameters belong to the second group, etc. Here, each group is one coordinate direction. The real-time data may be separated into different groups that correspond to the ordered parameter groups so that each group of data may be used to identify a group of parameters, with the data stored in one of the data buffers. Once sufficient data is available, corresponding parameters may be optimized by the order which is the order of the best opportunity. A search direction is chosen from the coordinate directions with the best converging opportunity, and a multivariable cost function is minimized along one direction of the coordinates at a time.

One embodiment of this optimization process is shown graphically with reference to FIG. 3, which includes a first parameter 302 and a second parameter 304. The first and second parameters 302, 304 may be selected from the first subset of parameters, with the first parameter 302 shown on the horizontal axis and the second parameter 304 shown on the vertical axis. The second subset of the parameters are presumed to have constant values. An initial state 301 is indicated. A first search may be executed for the first parameter 302, with the second parameter 304 held constant employing a multivariate cost function and a simplex search algorithm. Simplex search algorithms are known and not described herein. Convergence to a preferred state for the first parameter 302 may be determined by executing the multivariate cost function to minimize the cost while varying only the state of the first parameter 302. By way of example, the steady-state data stored in one of the data buffers 58, 59 may include a cylinder air charge that is associated with the MAF 33 that is measured by the mass airflow sensor 32, and time-correspondent states of a plurality of other engine operating parameters. The states of the other engine operating parameters may be employed in the cylinder air charge model employing EQS. 1 and 2, to estimate the cylinder air charge. The cost as determined by the multivariate cost function is preferably in the form of a difference between the estimated cylinder air charge and the MAF 33 that is measured by the mass airflow sensor 32. Preferably, after convergence to the first parameter 302 to a converged state 303, a second search may be executed for the second parameter 304, with the first parameter 302 held constant at its converged state 303 and employing a multivariate cost function and the simplex search algorithm. Convergence to a preferred state 305 for the second parameter 304 may be determined by executing the multivariate cost function to minimize the cost while varying only the state of the second parameter 304.

As such, the optimization routine can be executed to determine preferred states for the second subset of scalars k₃, k₄ and k₆, which are associated with engine operation that includes PVO based upon the engine operating data stored in the first data buffer 58, and then the optimization routine can be executed to determine preferred states for the first subset of scalars k₁, k₂, k₅ and k₇, which are associated with engine operation that includes NVO based upon the engine operating data stored in the second data buffer 59.

The process described herein provides a real-time parameter adaptation that may be employed in conjunction with a physics-based air charge model while accommodating engine variations. This serves to improve control performance by adapting air charge model to engine variations, and automatically self-adjusting parameters to accommodate engine wear over time. Thus, engine performance may be robust regardless of underlying engine variations. Such operation may reduce engine calibration time.

The first relationship, i.e., EQ. 1 of the first instruction set can be updated to determine the cylinder air charge during operation in the PVO state based upon the preferred states of the second subset of scalars k₃, k₄ and k₆, which are associated with engine operation that includes PVO. Likewise, the second equation of the second instruction set, i.e., EQ. 2 can be updated to determine the cylinder air charge during operation in the NVO state based upon the preferred states of the first subset of scalars k₁, k₂, k₅ and k₇, which are associated with engine operation that includes NVO.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method for controlling a direct-injection internal combustion engine including a plurality of moveable pistons reciprocating between a top-dead-center (TDC) position and a bottom-dead-center (BDC) position, a plurality of intake and exhaust valves, a first device disposed to control openings and closings of the plurality of intake valves and a second device disposed to control openings and closings of the plurality of exhaust valves in one of a positive valve overlap (PVO) state and a negative valve overlap (NVO) state, the method comprising:
gathering, via a controller, engine operating data during steady-state engine operation, including gathering a first dataset associated with a cylinder air charge during steady-state operation of the engine in the PVO state and gathering a second dataset associated with a cylinder air charge during steady-state operation of the engine in the NVO state;
executing an optimization routine to determine a first subset of parameters associated with a first relationship for a cylinder air charge model based upon the second dataset associated with steady-state operation of the engine in the NVO state;
executing the optimization routine to determine a second subset of parameters associated with a second relationship for a cylinder air charge model based upon the first dataset associated with steady-state operation of the engine in the PVO state; and
determining, via the controller, a cylinder air charge in real-time during engine operation based upon the cylinder air charge model and the first and second subsets of parameters.

2. The method of claim 1, wherein executing an optimization routine comprises executing a simplex search algorithm.

3. The optimization routine of claim 2, wherein executing the simplex search algorithm comprises executing a multivariate cost function to determine a cost associated with a difference between and estimated cylinder air charge and a measured cylinder air charge.

4. The method of claim 1, wherein executing an optimization routine to determine a first subset of parameters associated with a first relationship for a cylinder air charge model based upon the second dataset associated with steady-state operation of the engine in the NVO state comprises executing the optimization routine to achieve a converged state for a first parameter of the first subset of parameters while holding other parameters of the first subset of parameters constant.

5. The method of claim 1, wherein the first relationship comprises a determination of residual gas volume that is pushed to an intake port and re-inducted in a next engine cycle, as follows:
$${V}_{res}^{IP} ( n + 1 ) = {V}_{res}^{BDC} ( n ) \times ( 1 - \frac{{V}_{IVC} ( n \text{:} {k}_{5} )}{{V}_{BDC} ( n )} )$$
wherein:
Vᵣₑₛ^{BDC}(n) is total residual gas volume when the piston is at BDC for a current engine cycle, n,
V_{IVC}(n) is a cylinder volume when the intake valve closes during the current engine cycle, n, and k₅ is a scalar that is associated with valve timing bias,
V_{BDC}(n) is the cylinder volume when the piston is at BDC for the current engine cycle, n, and
Vᵣₑₛ^{IP}(n+1) is the volume of the residual gas trapped in the intake port that will be re-inducted into the cylinder during the next engine cycle, n+1.

6. The method of claim 1, wherein the second relationship comprises a determination of total residual gas volume Vᵣₑₛ^{BDC} at BDC determined in accordance with the following equation:
$${V}_{res}^{BDC} ( n ) = {k}_{1} \times {V}_{res}^{IP} ( n ) + {{k}_{2} ( \frac{{p}_{EM}}{{p}_{IM}} )}^{\frac{1}{γ}} {V}_{EVC} ( n \text{:} {k}_{7} ) + {V}_{res}^{PVO} ( n \text{:} {k}_{3} , {k}_{4} , {k}_{6} , {k}_{7} )$$
wherein:
n represents a current engine cycle,
Vᵣₑₛ^{IP}(n) is the residual gas volume forced into the intake port in a previous engine cycle and re-inducted to the cylinder in the current engine cycle,
P_{IM} is an intake manifold pressure,
P_{EM} is an exhaust manifold pressure,
γ is the ratio of specific heats for an ideal gas,
Vᵣₑₛ(n) is the residual gas volume in the cylinder originating from the current engine cycle, and
Vᵣₑₛ^{BDC}(n) is the total residual gas volume when the piston is at the BDC position for the current engine cycle, wherein
k₁ is a scalar to account for the residual gas volume reduction due to heat transfer at the intake port until the residual gas is re-inducted into the cylinder in the next engine cycle,
k₂ is a scalar to account for the residual gas volume reduction due to heat loss to the cylinder wall,
k₃ is a scalar that is associated with a mass to volume factor,
k₄ is a scalar that is associated with a crank angle at which flow to intake stops during PVO, and
k₆ and k₇ are scalars that are associated with valve timing bias.

7. A direct-injection, multi-cylinder internal combustion engine, comprising:
a plurality of moveable pistons slidably disposed in a corresponding plurality of cylinders, the pistons reciprocating between a top-dead-center (TDC) position and a bottom-dead-center (BDC) position;
a plurality of intake valves disposed to control intake airflow from intake ports into the cylinders;
a first device disposed to control openings and closings of the plurality of intake valves;
a plurality of exhaust valves disposed to control exhaust airflow out of the cylinders;
a second device disposed to control openings and closings of the plurality of exhaust valves;
wherein the first and second devices are disposed to control the plurality of intake valves and exhaust valves, respectively, in one of a positive valve overlap (PVO) state and a negative valve overlap (NVO) state;
a controller, operatively connected to the first and second devices and including a plurality of executable instruction sets and first and second data buffers, including:
a first instruction set executable to determine a cylinder air charge during operation in the PVO state, the first instruction set including a first relationship including a first subset of calibratable parameters,
a second instruction set executable to determine a cylinder air charge during operation in the NVO state, the second instruction set including a second relationship including a second subset of calibratable parameters, and
a third instruction set, executable to determine preferred states for the first and second subset of calibratable parameters, the third instruction set executable to:
gather engine operating data during steady-state operation of the internal combustion engine,
fill the first and second data buffers associated with operations in the NVO and PVO states, respectively with the engine operating data during the steady-state operation of the internal combustion engine,
execute an optimization routine to determine preferred states for the second subset of calibratable parameters associated with the NVO state based upon the engine operating data stored in the first data buffer,
execute the optimization routine to determine preferred states for the first subset of calibratable parameters associated with the PVO state based upon the engine operating data stored in the second data buffer,
update the first relationship of the first instruction set to determine the cylinder air charge during operation in the PVO state based upon the preferred states of the first subset of calibratable parameters, and
update the second relationship of the second instruction set to determine the cylinder air charge during operation in the NVO state based upon the preferred states of the second subset of calibratable parameters.

8. The internal combustion engine of claim 7, wherein the optimization routine comprises a simplex search algorithm.

9. The internal combustion engine of claim 8, wherein executing an optimization routine to determine a first subset of parameters associated with a first relationship for a cylinder air charge model based upon the second dataset associated with steady-state operation of the engine in the NVO state comprises executing the optimization routine to achieve a converged state for a first parameter of the first subset of parameters while holding other parameters of the first subset of parameters constant.

10. The internal combustion engine of claim 7, wherein executing the simplex search algorithm comprises executing a multivariate cost function to determine a cost associated with a difference between and estimated cylinder air charge and a measured cylinder air charge.

11. The internal combustion engine of claim 7, wherein the first device is disposed to control phasing and lift of each of the plurality of intake valves.

12. The internal combustion engine of claim 7, wherein the second device is disposed to control phasing and lift of each of the plurality of exhaust valves.

13. The internal combustion engine of claim 7, wherein the first relationship comprises a determination of residual gas volume that is pushed to an intake port and re-inducted in a next engine cycle, as follows:
$${V}_{res}^{IP} ( n + 1 ) = {V}_{res}^{BDC} ( n ) \times ( 1 - \frac{{V}_{IVC} ( n \text{:} {k}_{5} )}{{V}_{BDC} ( n )} )$$
wherein:
Vᵣₑₛ^{BDC}(n) is total residual gas volume when the piston is at BDC for a current engine cycle, n, and k₅ is a scalar that is associated with valve timing bias,
V_{IVC}(n) is a cylinder volume when the intake valve closes during the current engine cycle, n,
V_{BDC}(n) is the cylinder volume when the piston is at BDC for the current engine cycle, n, and
Vᵣₑₛ^{IP}(n+1) is the volume of the residual gas trapped in the intake port that will be re-inducted into the cylinder during the next engine cycle, n+1.

14. The internal combustion engine of claim 7, wherein the second relationship comprises a determination of total residual gas volume Vᵣₑₛ^{BDC} at BDC determined in accordance with the following equation:
$${V}_{res}^{BDC} ( n ) = {k}_{1} \times {V}_{res}^{IP} ( n ) + {{k}_{2} ( \frac{{p}_{EM}}{{p}_{IM}} )}^{\frac{1}{γ}} {V}_{EVC} ( n \text{:} {k}_{7} ) + {V}_{res}^{PVO} ( n \text{:} {k}_{3} , {k}_{4} , {k}_{6} , {k}_{7} )$$
wherein:
n represents a current engine cycle,
Vᵣₑₛ^{IP}(n) is the residual gas volume forced into the intake port in a previous engine cycle and re-inducted to the cylinder in the current engine cycle,
P_{IM} is an intake manifold pressure,
P_{EM} is an exhaust manifold pressure,
γ is the ratio of specific heats for an ideal gas,
Vᵣₑₛ(n) is the residual gas volume in the cylinder originating from the current engine cycle, and
Vᵣₑₛ^{BDC}(n) is the total residual gas volume when the piston is at the BDC position for the current engine cycle, wherein
k₁ is a scalar to account for the residual gas volume reduction due to heat transfer at the intake port until the residual gas is re-inducted into the cylinder in the next engine cycle,
k₂ is a scalar to account for the residual gas volume reduction due to heat loss to the cylinder wall,
k₃ is a scalar that is associated with a mass to volume factor,
k₄ is a scalar that is associated with a crank angle at which flow to intake stops during PVO, and
k₆ and k₇ are scalars that are associated with valve timing bias.

15. A direct-injection, multi-cylinder internal combustion engine, comprising:
a plurality of moveable pistons slidably disposed in a corresponding plurality of cylinders, the pistons reciprocating between a top-dead-center (TDC) position and a bottom-dead-center (BDC) position;
a plurality of intake valves disposed to control intake airflow from intake ports into the cylinders;
a first device disposed to control openings and closings of the plurality of intake valves;
a plurality of exhaust valves disposed to control exhaust airflow out of the cylinders;
a second device disposed to control openings and closings of the plurality of exhaust valves;
wherein the first and second devices are disposed to control the plurality of intake valves and exhaust valves, respectively, in one of a positive valve overlap (PVO) state and a negative valve overlap (NVO) state;
a controller, operatively connected to the first and second devices and including a plurality of executable instruction sets, including:
a first instruction set executable to determine a cylinder air charge during operation in the PVO state, the first instruction set including a first relationship including a first subset of calibratable parameters,
a second instruction set executable to determine a cylinder air charge during operation in the NVO state, the second instruction set including a second relationship including a second subset of calibratable parameters, and
a third instruction set, executable to determine preferred states for the first and second subset of calibratable parameters, the third instruction set executable to:
gather engine operating data during steady-state operation of the internal combustion engine associated with operations in the NVO and PVO states,
execute an optimization routine to determine preferred states for the second subset of calibratable parameters associated with the NVO state based upon the engine operating data associated with operation in the NVO state,
execute the optimization routine to determine preferred states for the first subset of calibratable parameters associated with the PVO state based upon the engine operating data associated with operation in the PVO state,
update the first relationship of the first instruction set to determine the cylinder air charge during operation in the PVO state based upon the preferred states of the first subset of calibratable parameters, and
update the second relationship of the second instruction set to determine the cylinder air charge during operation in the NVO state based upon the preferred states of the second subset of calibratable parameters.
